(19) United States
(12) Patent Application Publication
(10) Pub. No.: US 2020/0095524 A1
(43) Pub. Date: Mar. 26, 2020

(54) SYSTEMS AND METHODS FOR INSERT BASED WOOD AGING OF WHISKY AND OTHER ALCOHOLS

(71) Applicant: Joseph Keilman, Fort Collins, CO (US)

(72) Inventor: Joseph Keilman, Fort Collins, CO (US)

(21) Appl. No.: 16/580,685

(22) Filed: Sep. 24, 2019

Related U.S. Application Data
(60) Provisional application No. 62/736,000, filed on Sep. 25, 2018.

(51) Int. Cl. C12H 1/22; C12G 3/07

(52) U.S. Cl. CPC C12H 1/22; C12G 3/07

(57) ABSTRACT

The invention is an alternative barrel aging system that provides the advantages of a traditional all-wood barrel aging system by providing a reusable container fashioned to receive replaceable inserts and replaceable inserts sized to fit into the reusable container.

### CROSS REFERENCE TO RELATED APPLICATIONS

This application claims priority to and the benefit of U.S. Provisional Application No. 62/736,000, filed Sep. 25, 2018, which is hereby incorporated by reference in its entirety.

### FEDERALLY SPONSORED RESEARCH OR DEVELOPMENT

None.

### BACKGROUND

Traditional aging of whisky and other alcohols requires wooden barrels that degrade and have to be replaced, which is burdensome and expensive. There is a need for an improved whisky aging system that provides the same results as wood barrel aging without the burden and expense of using traditional wooden barrels.

In the early 2010's, a barrel shortage hamstrung new distilleries from whisky manufacturing because whisky cannot be made without oak aging. The shortage resulted from a downturn in the construction industry, as well as poor logging conditions in general. Barrels require the highest quality of scarce white oak wood, which means a good sized, 100-year-old oak tree will only have suitable wood to produce part of a single barrel. While production has stabilized, there is always the possibility of economic or environmental issues limiting the oak supply again. Barrels require the highest quality lumber from the trunk of the tree. There is thus a need for aging that allows for wood of more common quality to be used, including suitable branches, meaning even in the event of an oak shortage, an aging system could still be manufactured with minimal disruption. The labor requirements for traditional cooperage are also high as skilled labor and specialized equipment is required to build a barrel.

The aging process is the interaction of three things: the alcohol, the wood and char of the barrel itself and the outside atmosphere. The alcohol is filtered by the charred layer inside the barrel and pulls sugars and other flavor/aroma compounds out of the wood. The changing outside atmospheric conditions (temperature, humidity, pressure, etc.) push and pull the alcohol in and out of the wood. At the same time, a small amount of the water and alcohol evaporate off, the so-called angel's share. While this may seem at first glance to be unwanted, the result is that the flavors and richness of the remaining contents is increased, as though one was simmering a sauce to concentrate the flavors. At the same time, a small amount of air works its way into the product, causing a micro-oxygenation of the product, further enhancing its flavor though the chemical reaction of the oxygen entering the product. Thus, there is a need for barrels to permit micro-oxygenation to occur.

The accepted ideal for aging spirits is the 53-gallon barrel. It gives flavor and controls evaporation, as well as having a standard construction. The ratio of the surface area of the interior of the barrel to the volume is the key to replicating full sized barrel-aging. A smaller barrel has much higher amount of surface area to volume, which can lead to some flavors being over-represented too quickly compared to a standard barrel. Thus, there is a need to have proper surface area ratio to correctly age a product.

In regard to patent publication US 2010/0025396 A1, the ‘heads only’ system can be roughed and carved to increase surface area. However, by only having two surfaces in which to do this, there can be a significant thinning of the wood in the top and bottom of the container. Due to the thinning, or by other causes, should the wood portion fail, the valuable contents will be at best partially lost, and at worst, completely lost or contaminated.

The multiple slats of wood used in the construction of each head still have the weaknesses of traditional barrels: leaking, cracking, or insufficient preparation can lead to loss of product. It also still requires the highest quality material and skilled (albeit less) labor of traditional barrel heads.

Finally, the greatly reduced amount of wood leads to a greatly reduced ratio of surface area to liquid volume in the product. There is no mention in '396 of matching these aspects of a traditional barrel. As mentioned above, increasing the surface area to come even close to a barrel will weaken the wood. Even if the wood could match the surface area ratio, there will be a greatly reduced action of the wood due to less action from the ambient atmosphere and thus less ‘angel's share’ and other actions that occur during aging. Non-oak woods would need to be avoided due to the thin heads would allow seeping of product.

In regard to U.S. Pat. No. 9,885,010 B2, the exterior slats can cause problems due to wood splitting or cracking on its own or from any impacts to the container. Should that occur, the entire unit would need to be emptied before replacing a damaged slat, leading to lost product. The same issue arises should a gasket or other sealing system fail. There is also no mention of the surface area ratio matching that of a barrel.

In regard to U.S. Pat. No. 3,942,423 A, there is a single size designed to fit only one insert into in a glass carboy. This single insert provides less than 20% of a 53-gallon barrel's surface area to the volume of product in the carboy. The insert is not charred or toasted, leading to an unpalatable product in a short period of time. The walls of the insert are thin, and liquid can seep through, rather than evaporate through the angel's share mechanism. These are substantial problems of the '423 patent.

### SUMMARY

Full-sized oak barrels are generally large and bulky, resulting in extremely high purchasing and shipping prices for a relatively small number of units. The invention is an alternative barrel aging system that can provide the advantages of a traditional barrel aging system. It provides increased flexibility with an aging solution that delivers a lower price by incorporating less material and lower labor and shipping costs, while at the same time delivering the results of aging in a full-sized barrel, regardless of the size of the container.

### BRIEF DESCRIPTION OF THE DRAWINGS

The invention will be better understood by a reading of the Detailed Description along with a review of the drawings in which:

FIG. 1 shows a full-length view of the insert, showing the grooves that are running down the length of the insert. The char has been omitted for clarity.

FIG. 2 shows a top view, illustrating the bore that is drilled from the top, and narrowing of the tip to be put into a plug or gasket.

FIGS. 3a -3b shows different groove patterns or cuts made to increase surface area.

FIG. 4 shows an exploded 4-insert example.

FIG. 5 shows a sealed 4-insert example tank.

FIGS. 6 and 7 show a plug or gasket that stops alcoholic products from uncontrolled evaporation.

### DETAILED DESCRIPTION

The invention is an alternative barrel aging system that essentially works like a traditional barrel and provides all the benefits at a lower price point. A distiller can fill a unit, allow the product to age, then bottle, clean the tank, replace the teeth and start again. The used, whiskey-infused teeth can be put in another tank to make products like cask rum or to infuse specific flavors into other liquids.

A wooden dowel of white oak or other desired wood with sufficient length and diameter is selected. A hole is bored into one end of the dowel, going down into the dowel, but leaving the other end sealed. If desired, the surface area can be increased via grooving with a device like a router or shallow drill holes. The dowel is then toasted or charred as a traditional barrel, if desired.

To address the problems that existed, the invention allows for wood of more common quality to be used, including suitable branches, meaning even in the event of an oak shortage, the invention could still be manufactured with minimal disruption. The labor requirements for the invention are also minimal compared to traditional cooperage. Skilled labor and specialized equipment is required to build a barrel, whereas any equipped woodshop would be able to make the invention with ease.

To permit micro-oxygenation to occur, the invention has a borehole down one end of the dowel, leaving the submerged end sealed. This allows the interaction with the atmosphere and provides all the benefits described above. As a counter-example, a piece of oak simply left in the product inside a sealed container has no access to the outside atmosphere, so the above benefits are lost.

The invention maintains proper surface area to volume ratio and is scale-able, allowing the traditional 53-gallon barrel to be replaced with a unit of desired size. Smaller units will use a smaller number of inserts, while still keeping the full-sized barrel surface area to volume ratio. This can be vital to smaller producers who are interested in testing recipes to see how they would turn out in a full-sized aging system. A failed 53-gallon batch still requires hundreds of dollars in costs, not to mention the time and ingredients lost. For interested producers, there is also the possibility of ‘over-oaking’, that is, adding more inserts or surface area than the full-sized barrel ratio. This could change the flavor of the final product and could also speed the rate of aging. “Under-oaking” could also be attempted.

The invention also allows for alternative woods not suitable for traditional barrels to be used to give producers a wider pallet of flavors to experiment with. The walls of the invention are also thick enough to not allow wicking or seeping.

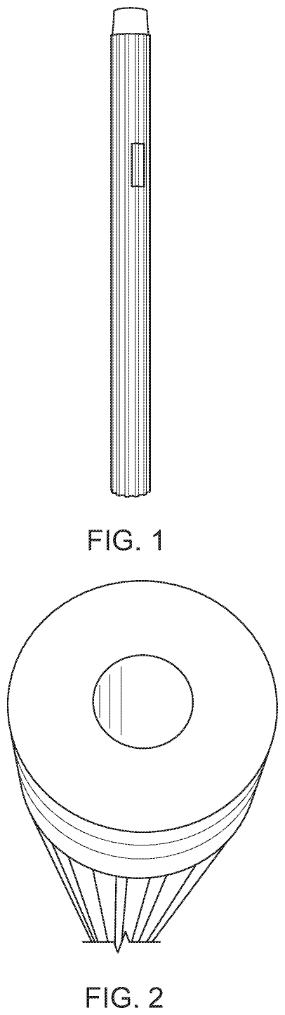

As seen in FIG. 1, the exterior has the top few inches narrowed to be inserted into a plug or gasket that stops alcoholic products from uncontrolled evaporation.

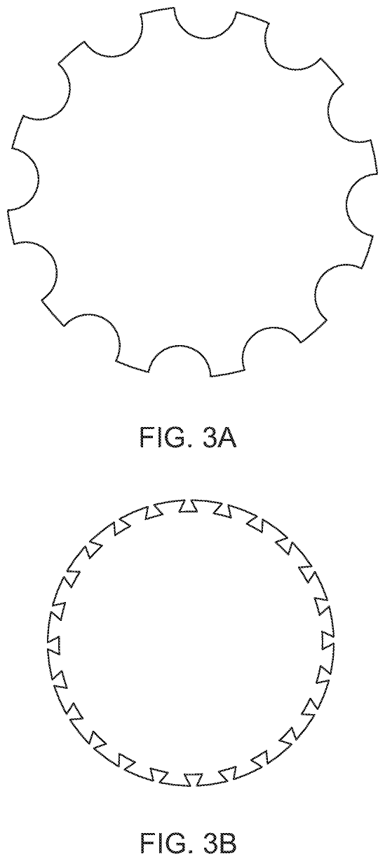

As seen in FIG. 2, the replaceable wood inserts are toasted or charred as per traditional barrel manufacturing. In a traditional barrel, the inside is toasted (heated till it browns, which is often done for oak-aged wines) or charred (set on fire, which is often done for spirits). The alcohol is then added in and the barrel is sealed. During the months-to-years in the barrel, a number of things are happening to the liquid inside. The oak is full of flavor and aroma compounds that dissolve into the liquid. Just as in a traditional barrel, the charred layer acts as an activated charcoal filter, grabbing onto unwanted flavor compounds that would make the product less appealing. All this is assisted by external weather conditions, temperature, air pressure, humidity etc., force the spirits in and out of the wood, which has access to the full length of the insert via the bore hole.

As seen in FIG. 2 the charred oak inserts have a hole drilled from the top to ⅘ths of the length of the insert, leaving it sealed on one end. The hole allows air to move in and out of the insert, properly mimicking the ‘breathing’ action of a traditional barrel and allowing for the ‘angel's share’ or evaporation of water and alcohol through the wood. While one might assume this is unwelcomed, it has the effect of concentrating flavors and richness, much in the same way one might simmer a sauce down. This breathing also allows the atmosphere to micro-oxygenate the product inside. If a barrel did not have access to the ambient atmosphere, these actions would slow considerably, and if a piece of oak was left in a sealed container of steel or something similar, there would be zero angel's share action.

As seen in FIG. 2, the hole's diameter leaves the remaining wood in the dowels roughly at the same thickness as a barrel stave. The length, grooving and number of inserts can always be made to match the surface area ratio that is matched to a full-sized barrel, or to other formats as the producer wishes. The who

As seen in FIG. 2, the total insert diameter may be between 2 and 4 inches, but other sizes may also be used.

Referring to FIGS. 3a and 3b, the exterior is textured with vertical grooves to increase surface area to match the ratio of liquid to surface area found in a traditional barrel. Other barrel aging systems exist, ranging from oak chunks floating in alcohol inside a closed container to adding internal slats to an existing barrel, but all these lack one or more of the interactions of the ‘aging trinity’: the alcohol, char and wood of the barrel, and the external atmosphere all need to interact in the correct ratios. The invention maintains all of these at the same level as a traditional fifty-three-gallon whisky barrel, where the ratio of surface area to the volume of the liquid is roughly 55.75 inches' of charred surface per gallon.

This figure is important as it is what the ratio should be for a product to age at the proper rate. As a traditional container gets smaller, the ratio changes dramatically. The issue that arises in a smaller container is that the aging process is rapidly sped up by more liquid being in contact with oak. This might initially seem to be a positive, however, some flavor compounds get pulled out too much, and some do not get pulled out enough, and there isn't enough time for the angel's share to develop before the wood overpowers the flavor. The result can still be a decent product, but it is understood that it would be even better in a full-sized barrel.

Mathematical modeling gives the invention an internal geometry comparable to a full-sized barrel, meaning it will age at the same rate, and give the same benefits as a traditional barrel. The system can be scaled up or down and use types of wood that are not able to be used in traditional barrels, leading to extremely unique flavors that might not have any other way to be created.

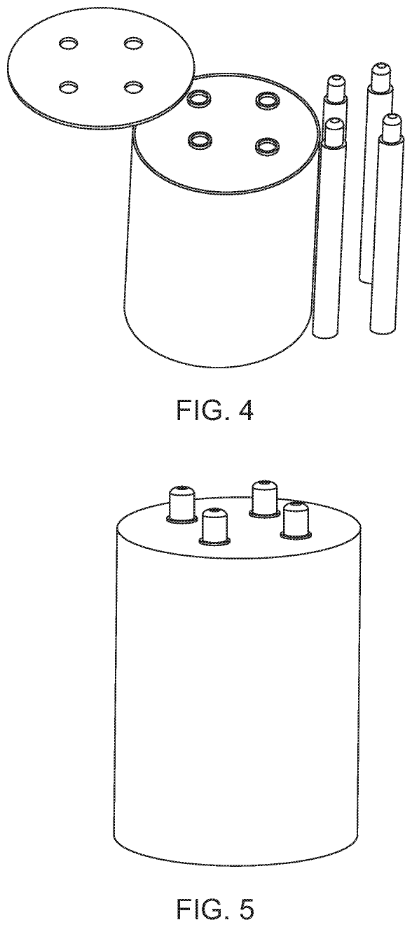

As seen in FIG. 4, the invention comprises of a reusable steel, plastic, or other liquid-impermeable tank and replaceable wooden inserts. The inserts are made of dried American white oak, though other wood types can be used as per the preference of the producer. The oak dowels are a more efficient use of the oak than are traditional barrels and can be made of parts of the tree not suitable for barrel stave construction. The tank is reusable and new inserts can be installed after aging is complete.

As seen in FIG. 4, the insert is placed in a plug and placed in the container. In comparison, a full-sized barrel would use 8 inserts.

As seen in FIG. 5, the 4-insert example tank is sealed.

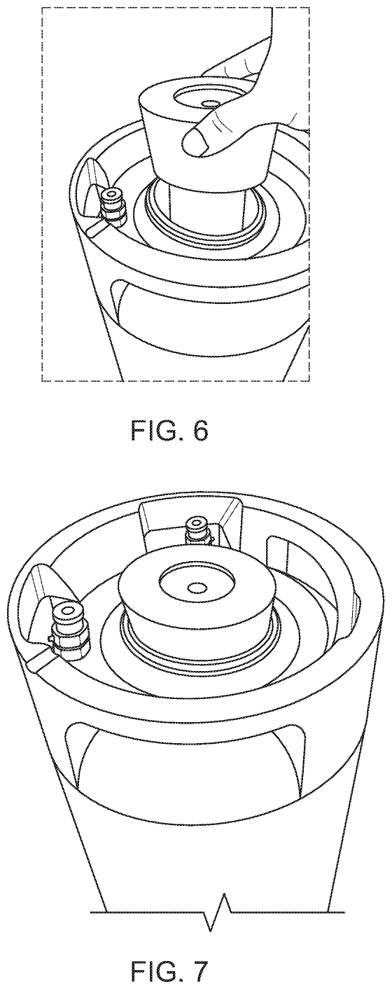

As seen in FIG. 5, the gasket fits between the lid and the shoulder of the insert. This is also demonstrated in FIG. 6, which features an early prototype of the invention.

As seen in FIGS. 6 and 7, a plug or gasket stops alcoholic products from uncontrolled evaporation from the tank.

Another aspect of the invention is its ability to use woods that are typically not suitable for use in barrel construction. White oak is the standard due to its flavor profile. In addition, its cellular structure is very dense and keeps liquid from leaving the container. The metal hoops around a barrel squeeze the staves together so tightly that it essentially functions like one piece of wood. Unlike traditional barrels, the invention can also be used with multiple types of wood outside of the traditional American and European white oak, so producers could age their beverage using anything from cherry to pecan giving them total control over their product. These may give incredibly unique flavors to products, and it's possible that craft distillers could build an entire product line around a local tree species, giving even more of a local story to their spirits.

The invention is designed to have as few or as many inserts as the producer requires to overcome the problems described in the background above. As such, scaling down a full sized 53-gallon (or greater) vessel to a 5-gallon test container, or scaling up to larger than a 53-gallon container, would be able to be used with 100% of the aging qualities of a standard sized barrel.

All publications and patent documents cited in this application are incorporated by reference in pertinent part for all purposes to the same extent as if each individual publication or patent document were so individually denoted. By citation of various references in this document, Applicants do not admit any particular reference is “prior art” to their invention. It is to be appreciated that the foregoing Detailed Description section, and not the Abstract section, is intended to be used to interpret the claims. The Abstract section may set forth one or more, but not all, exemplary embodiments of the present invention as contemplated by the inventor(s), and thus, is not intended to limit the present invention and the appended claims in any way.

The foregoing description of the specific embodiments should fully reveal the general nature of the invention so that others can, by applying knowledge within the skill of the art, readily modify and/or adapt for various applications such specific embodiments, without undue experimentation, without departing from the general concept of the present invention.

Moreover, the breadth and scope of the present invention should not be limited by any of the above-described exemplary and illustrative embodiments, but should similarly be defined only in accordance with the following claims and their equivalents.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents. From the foregoing, it will be seen that this application is one well adapted to attain all the ends and objects hereinabove set forth together with other advantages which are obvious and which are inherent to the structure.

It will be understood that certain features and sub-combinations are of utility and may be employed without reference to other features and sub-combinations. This is contemplated by and is within the scope of the claims.

What is claimed is:

1. An alcohol aging system comprising:
a reusable liquid-impervious container fashioned to receive a replaceable insert; and, a replaceable insert sized to fit into the container.

2. The alcohol aging system of claim 1, wherein the container is made of metal.

3. The alcohol aging system of claim 2, wherein the metal is steel.

4. The alcohol aging system of claim 1, wherein the container is made of plastic.

5. The alcohol aging system of claim 1, wherein the insert is made of wood.

6. The alcohol aging system of claim 5, wherein the insert has a borehole.

7. The alcohol aging system of claim 1, wherein the insert is placed in a plug in the container.

8. The alcohol aging system of claim 7, wherein the insert is made of wood.

9. The alcohol aging system of claim 8, wherein the insert has a borehole.

10. The alcohol aging system of claim 1, wherein the container is fashioned to receive a plurality of replaceable inserts.

11. The alcohol aging system of claim 10 comprising a plurality of replaceable inserts.

12. The alcohol aging system of claim 11, wherein the inserts are made of wood.

13. An insert sized to fit into a reusable liquid-impervious alcohol aging container.

14. The insert of claim 14, wherein the container is made of metal.

15. The insert of claim 15, wherein the metal is steel.

16. The insert of claim 13 made of wood.

17. The insert of claim 16 having a borehole.

18. A set of inserts sized to fit into a reusable liquid-impervious alcohol aging container.

19. The set of inserts of claim 18 wherein each insert is made of wood.

20. The set of inserts of claim 19 having a borehole in each insert.
